(19) United States
(12) Patent Application Publication
(10) Pub. No.: US 2026/0339325 A1
(43) Pub. Date: Oct. 29, 2026

(54) SPARSE CLOSED-FORM LIQUID NEURAL ALGORITHMS FOR OUT-OF-DISTRIBUTION GENERALIZATION ON EDGE ROBOTS

(71) Applicant: Massachusetts Institute of Technology, Cambridge, MA (US)

(72) Inventors: Ramin Hasani, New York, NY (US); Daniela L. Rus, Weston, MA (US); Alexander Amini, Brookline, MA (US); Mathias Lechner, Cambridge, MA (US); Makram Chahine, Cambridge, MA (US)

(73) Assignee: Massachusetts Institute of Technology, Cambridge, MA (US)

(21) Appl. No.: 19/116,471

(22) PCT Filed: Aug. 14, 2023
(86) PCT No.: PCT/US2023/072140

§ 371 Date: Mar. 28, 2025

Related U.S. Application Data
(60) Provisional application No. 63/415,382, filed on Oct. 12, 2022.

(51) Int. Cl. G05D 1/243; G05D 101/15; G05D 109/25; G06N 3/044; G06V 10/82; G06V 20/17

(52) U.S. Cl. CPC G05D 1/243; G06N 3/044; G06V 10/82; G06V 20/17; G05D 2101/15; G05D 2109/254

(57) ABSTRACT

According to one aspect, a system includes an autonomous agent and a sparse closed-form network. The autonomous agent has one or more cameras configured to receive images of an environment in which the agent is operating, one or more motors, and a controller configured to command the motors to move the agent with desired velocities. The sparse closed-form network is configured to process the images to determine the desired velocities for navigating the agent to a target.

### CROSS-REFERENCE TO RELATED APPLICATIONS

This application claims the benefit under 35 U.S.C. § 119 of U.S. Provisional Patent Application No. 63/415,382 filed on Oct. 12, 2022, which is hereby incorporated by reference herein in its entirety.

### STATEMENT REGARDING FEDERALLY SPONSORED RESEARCH

This invention was made with government support under N00014-18-1-2830 awarded by the Office of Naval Research, and FA8750-19-2-1000 awarded by the Air Force Research Laboratory. The government has certain rights in the invention.

### BACKGROUND

Autonomous robots can learn to perform visual navigation tasks from offline human demonstrations and generalize well to online and unseen scenarios within the same environment they have been trained on. It is challenging for these agents to take a step further and robustly generalize to new environments with drastic scenery changes they have never encountered before.

Intelligence in natural brains differs from today's deep learning systems. The differences are rooted in the ways these systems learn to make sense of their environment and manipulate it to achieve their goals. Natural learning systems interact with their environments to understand their world. Understanding can be defined as the ability to capture causality and contexts while learning abstract concepts to reason, plan and control. This rich representation learning capability allows agents to extrapolate and perform inference and credit assignment even in novel scenarios and out-of-distribution (OOD), which is currently beyond the performance achievable with either overparameterized deep learning systems or classical statistical learning theory analysis, as deep models overfit to their training data and statistical learning theory requires i.i.d conditions on the data.

Studying natural brains can effectively narrows the search space of possible algorithms for acquiring intelligent behavior. For instance, neural circuits in brains are significantly more robust to perturbations and distribution shifts than deep neural networks, while also being more flexible in tackling uncertain events compared to deep learning systems. This is because they deploy both unconscious (to facilitate changes in distributions, faster) and conscious (to distill causal structure of data and manipulate learned concepts and models) processes for decision-making. In contrast, today's deep learning systems are incapable of capturing causality using extracted concepts and features explicitly, despite being able to learn fast from implicit types of observations.

### SUMMARY

Disclosed herein are concepts, structures, and techniques for providing robust flight navigation agents that successfully perform vision-based fly-to-target tasks beyond their training environment under drastic distribution shifts. In one aspect, an imitation learning framework and an algorithm called sparse closed-form networks (CfCs) is described. Sparce CfCs (also referred to herein as simply CfCs) are based on liquid neural networks, a brain-inspired class of continuous-time neural models that are causal and adapt to changing conditions. Liquid agents can learn to distill the task they are given from visual inputs and drop irrelevant features. This way, they transfer their learned navigation skills to new environments. Sparse CfCs are shown to provide robustness in decision-making compared to other state-of-the-art deep agents.

This disclosure describes how biologically-inspired priors on neural models and network architectures can lead to more flexible, robust, and understandable decision-making for autonomous robots. In particular, it describes concepts, structures, and techniques for providing agents capable of generalizing and achieving zero-shot transfer to new environments for some tasks.

In some embodiments, disclosed concepts, structures, and techniques can be applied to end-to-end drone navigation tasks from pixel inputs. For example, consider a scenario where the objective is for a drone agent to navigate to a static target placed in a forest environment. Neural network agents can be trained on a few runs of data collected by a pilot (e.g., a human pilot) in an offline supervised learning setting. Using disclosed concepts, structures, and techniques, such agents may transfer well under changes in scenery and conditions, such as changing from summer to winter landscapes.

Specifically, embodiments of the present disclosure provide for learning-based solutions to robot flight control that are robust and transferable to novel environments. In the context of the context of the flight hiking task, a quadrotor robot controller can be trained, in one environment, to recognize and navigate towards a target by imitation learning. The resulting policy can then be deployed to recognize and move to the target iteratively in different environments. Achieving good out-of-distribution performance requires that trained models learn representations that are causally associated with the task, compositionally resilient, and independent of the environmental context.

In contrast to prior art that has focused on providing a better gradient descent-based learning scheme without consideration of the structure of the underlying policy architecture, the present disclosure leverages brain-inspired pipelines and demonstrates that if the causal structure of a given task is captured by a neural model from expert data, then the model can perform robustly even out-of-distribution (OOD). Disclosed embodiments utilize liquid neural networks that generalize well to many OOD settings (e.g., fly-to-target tasks with different time horizons), achieving performance beyond state-of-the-art models.

Models that can be trained in one environment to perform in a multitude of other environments have a certain degree of robustness, achieving zero-shot generalization. One approach to obtain such control policies is by scaling up their size with structural scaling of neural network policies. It is appreciated herein that on resource-constrained embedded systems such as aerial robots, it may be infeasible to take advantage of the generalization properties of large models due to their high computational cost of inference. Liquid time-constant (LTC) networks (or shorter, liquid networks) are a class of compact and brain-inspired continuous-time recurrent neural networks (RNNs) that can be used to model, for example, autonomous navigation of ground and simulated drone vehicles, end-to-end in closed-loop with their environments. Liquid networks are formulated by a nonlinear state-space representation that possesses the ability to account for external and internal interventions during training and, thus, may be used for OOD generalization.

According to one aspect of the present disclosure, a system can include an autonomous agent and a sparse closed-form network. The autonomous agent can have one or more cameras configured to receive images of an environment in which the autonomous agent is operating, one or more motors, and a controller configured to command the motors to move the autonomous agent with desired velocities. The sparse closed-form network can be configured to process the images to determine the desired velocities for navigating the autonomous agent to a target.

According to another aspect of the present disclosure, a computer-implemented method can include: receiving images from one or more cameras of an autonomous agent, the images being image of an environment in which the autonomous agent is operating, the autonomous agent having one or more motors and a controller configured to command the motors to move the autonomous agent with desired velocities; and processing the images using a sparse closed-form network to determine the desired velocities for navigating the autonomous agent to a target.

In some embodiments, the sparse closed-form network can be trained on image data collected during one or more prior operations during which the autonomous agent is navigated to the target. In some embodiments, such training runs may be performed within another environment different from the environment in which the autonomous agent is subsequently operating. In some embodiments, the autonomous agent can comprise a quadcopter or other type of drone. In some embodiments, the sparse closed-form network may be provided as a recurrent neural network (RNN). In some embodiments, the sparse closed-form network can have a connectome architecture.

In some embodiments, the connectome architecture can be generated (e.g., by one or more processors of the system) by Sparse-CfC wiring and running inference on the Sparse-CfC wiring. In some embodiments, creating the Sparse-CfC wiring can include: connecting inputs to a first hidden layer of a graph; connecting the first hidden layer to a second hidden layer of the graph; recurrently connecting the second hidden layer of the graph; and connecting the second hidden layer of the graph to an output layer of the graph.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1A is a schematic diagram of a fully connected liquid time-constant (LTC) network layer.

FIG. 1B is a schematic diagram of a closed-form liquid network (CfC) together with its state equation, which may be utilized for out-of-distribution (OOD) generalization on edge robots, according to some embodiments.

FIG. 1C is a schematic diagram of a neural circuit policy (NCP) having a network architecture inspired by the neural circuits of the nematode C. elegans.

FIG. 1D is a schematic diagram of a sparse neural circuit with the same general architecture as with the NCP of FIG. 1C, but instead using CfC neural dynamics.

FIG. 2 is a block diagram of a robotic system utilizing a Sparse-CfC network to learn and execute navigation tasks with OOD generalization, according to some embodiments.

FIG. 2A shows an example of a neural network controller architecture that may be used within the system of FIG. 2, according to some embodiments.

FIGS. 3A and 3B are pictorial diagrams showing task learning and OOD generalization that may be performed using disclosed concepts, structures, and techniques.

FIG. 3C illustrates the causal mechanisms underlying the behaviors of different networks described herein.

FIGS. 3D-F illustrates a process for training a neural network for use with an autonomous robot, according to some embodiments.

FIG. 3G illustrates operation of an autonomous robot using a trained network model, according to some embodiments.

FIG. 4 is a flow diagram showing a method for navigating an autonomous agent to a target using a Sparse-CfC network, according to some embodiments.

The drawings are not necessarily to scale, or inclusive of all elements of a system, emphasis instead generally being placed upon illustrating the concepts, structures, and techniques sought to be protected herein.

### DETAILED DESCRIPTION

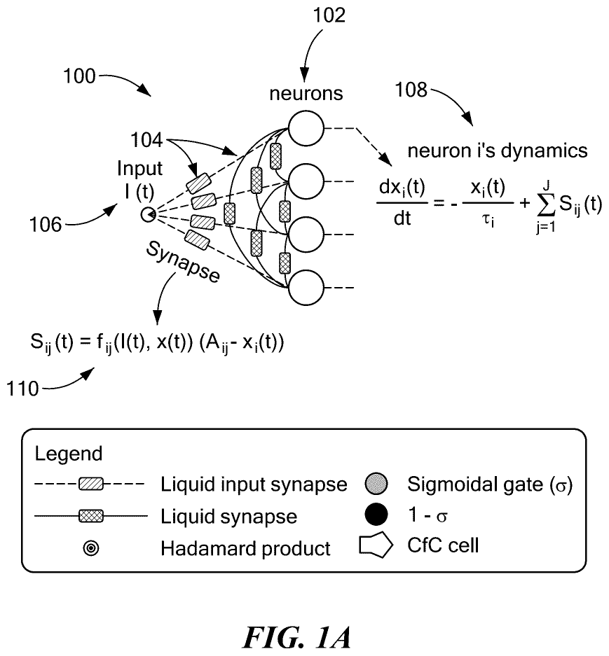

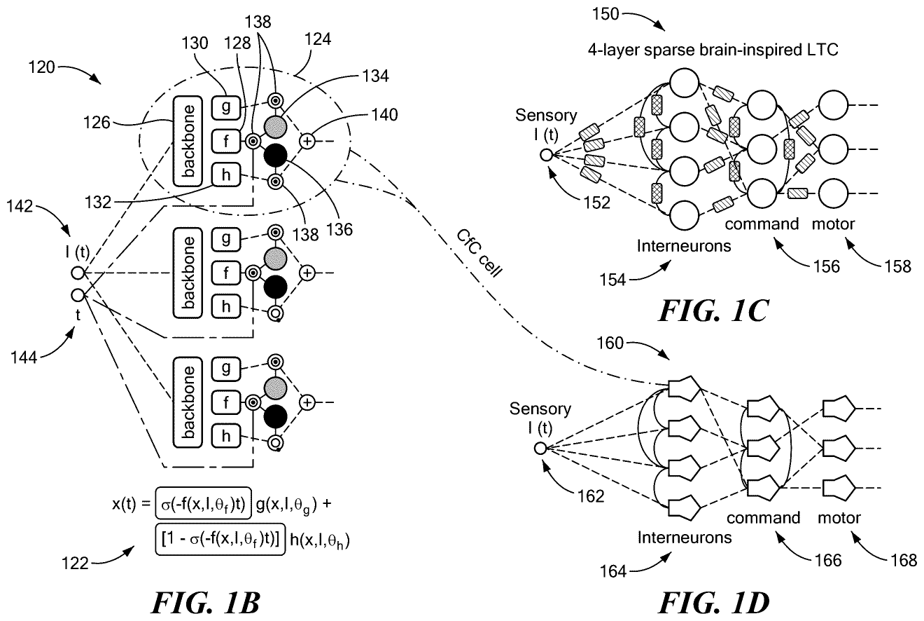

Turning to FIGS. 1A-D, a bottom-up approach to building brain-inspired neural models is to examine how neurons interact with each other through synapses in small biological brains. Three mechanisms may be identified for information propagation that are abstracted away in the current building blocks of neural network-based controllers: 1) neural dynamics are typically continuous processes described by differential equations, 2) synaptic release is more than scalar weights: it involves a nonlinear transmission of neurotransmitters, the probability of activation of receptors, and the concentration of available neurotransmitters, among other nonlinearities, and 3) the propagation of information between neurons is induced by feedback and memory apparatuses. These biological priors lead to the design of neural and synapse building blocks at a level of abstraction that is scalable and enriching with neural information processing attributes. The class of liquid neural networks known as liquid time-constant (LTC) accommodates these three criteria.

FIG. 1A shows an example of a fully connected LTC layer 100 having neurons 102 and synapses 104, and taking input I(t) 106. The dynamics of a single neuron i is given by equation 108, where xᵢ(t) represents the state of the neuron i, and t represents the neuronal time constant. Synapses 104 are given by a nonlinear function 110, where f(⋅) represents a sigmoidal nonlinearity, Aᵢⱼ is a reversal potential parameter for each synapse from neuron j to i.

The legend shown with FIG. 1A also applies to FIGS. 1B-C.

FIG. 1B shows a continuous-time representation of a closed-form liquid network (CfC) 120 together with its state equation 122. Network 120 includes a plurality of cells, with cell 124 being representative. A cell 124 can include a backbone 126, a nonlinear neural layer f 128, two other nonlinear layers g 130 and h 132, two sigmoidal gating mechanisms σ 134 and 1−σ 136, along with Hadamard products 138, and a summation element 140, which network elements may be connected as shown in the figure. Each of the CfC cells may be coupled to receive input I(t) 142 and time t 144. The activity of the two sigmoidal gating mechanisms, σ 134 and 1−σ 136 is regulated by the nonlinear neural layer f 128, which acts as the liquid time-constant for CfCs. Gating mechanisms 134, 136 control the two other nonlinear layers g 130 and h 132 to create the state of the system.

FIG. 1C shows a neural circuit policy (NCP) 150 with a network architecture inspired by the neural circuits of the nematode C. elegans. It is constructed by four sparsely connected LTC layers called: sensory neurons 152, interneurons 154, command neurons 156, and interneurons 158.

FIG. 1D shows an example of a sparse neural circuit 160 with the same architectural motifs as NCPs (e.g., the same general architecture as shown in FIG. 1C), this time with CfC neural dynamics. In more detail, circuit 160 has four sparsely connected CfC layers, also called: sensory neurons 162, interneurons 164, command neurons 166, and interneurons 168.

LTCs can be constructed by the interaction of leaky-integrator neural models with the steady-state dynamics of a conductance-based nonlinear synapse model. The model is a differentiable dynamical system with an input-dependent varying (i.e., liquid) time characteristic. Their outputs are computed by numerical differential equation (DE) solvers when described by ordinary DEs and by continuous functions when described in closed-form approximations (FIG. 1B). These brain-inspired models are instances of continuous-time (CT) neural networks that can be trained via gradient descent in modern automatic differentiation frameworks.

Liquid networks exhibit stable and bounded behavior, yield superior expressivity within the family of CT neural models, and give rise to improved performance on a wide range of time series prediction tasks compared to advanced, recurrent neural network models. In particular, a sparse network configuration composed of less than two dozen LTC neurons supplied with convolutional heads showed great promise in learning, end-to-end, to map high-dimensional visual input stream of pixels to robust control decisions. These liquid network instances are called neural circuit policies (NCPs), as their 4-layered network structure is inspired by the neural circuits of the nervous system of the nematode C. elegans, as illustrated in FIGS. 1C and 1D.

The state-space representation of a Liquid Constant Time (LTC) neural network can be determined by the following set of ODEs:

$$\\ \begin{matrix}\frac{dx ( t )}{dt} = - [ \frac{1}{τ} + f ( x ( t ) , I ( t ) , t , θ ) ] ⊙ x ( t ) + f ( x ( t ) , I ( t ) , t , θ ) ⊙ A . & ( 1 )\end{matrix}$$

Here, x^{(D×1)}(t) is the hidden state with size D, I^{(m×1)}(t) is an input signal, τ^{(D×1)} is the fixed internal time-constant vector), A^{(D×1)} is a bias parameter, and ⊙ is the Hadamard product. Intuitively, LTC networks are able to change their equations based on the input they observe. These networks, either in their ODE form or in their closed-form representation demonstrate remarkable causality and generalizability in modeling spatiotemporal dynamics compared to their counterparts. Their closed-form representation is called Closed-form Continuous-time (CfC) models and are given by:

$$\\ \begin{matrix}x ( t ) = σ ( - f ( x , I ; {θ}_{f} ) t ) ⊙ g ( x , I ; {θ}_{g} ) + [ 1 - σ ( - [ f ( x , I ; {θ}_{f} ) ] t ) ⊙ h ( x , I ; {θ}_{h} ) ] . & ( 2 )\end{matrix}$$

Here, f, g, and h, are three neural network heads with a shared backbone, parameterized by θ_{f}, θ_{g}, and θₕ, respectively. I(t) is an external input, and t is time sampled by input timestamps, as illustrated in FIGS. 1A-D.

Next described is an algorithm that combines the representation learning of liquid networks and sparse connectivity structure of a neural circuit policies, according to embodiment of the present disclosure. The algorithm can be utilized by autonomous robots or agents (e.g., such as drones for navigation with OOD generalization, as described in detail below.

LTCs and CfCs such as shown in FIGS. 1A and B standalone may not generalize well to out-of-distribution modes. To improve over this, a new network architecture is disclosed that shares connectome structure with neural circuit policies and enhances the generalization performance of liquid networks in OOD settings. The connectome architecture of the Sparse-CfC is obtained by Algorithms 1 to 6.

```
Algorithm 1: Create Sparse-CfC Wiring
Require: Sensory neurons Nₛ, inter neurons Nᵢ, command N_{c}, motor neurons Nₘ,
density parameters kₛ, kᵢ, k_{c}, and kₒ.
    Construct graph (V, E) with V = Nₛ ∪ Nᵢ ∪ N_{c} ∪ Nₘ and E = { }
    call Algorithm 3: Connect inputs to first hidden layer
    call Algorithm 4: Connect first hidden layer to second hidden layer
    call Algorithm 5: Recurrently connect second hidden layer
    call Algorithm 6: Connect second hidden layer to output layer
    return (V, E)
```

Algorithm 2: Run Inference of Sparse-CfC Wiring

```
Require: Sensory neurons Nₛ, inter neurons Nᵢ, command N_{c}, motor neurons Nₘ,
wiring graph (V, E), input I, current hidden state x.
    Initialize next hidden state x′ for neurons Nᵢ, N_{c}, and Nₘ with all zeros
    for all n ∈ Nᵢ do
      ${x}_{n}^{′} \to Eq . 2 with current hidden state {x}_{n} and input \{ {I}_{i} \vert i ∈ I and ( i , n ) ∈ {E}_{n} \}$
    end for
    for all n ∈ N_{c} do
      ${x}_{n}^{′} \to Eq . 2 with current hidden state {x}_{n} and input \{ {x}_{i}^{′} \vert i ∈ {N}_{s} and ( i , n ) ∈ {E}_{n} \}$
    end for
    for all n ∈ Nₘ do
      ${x}_{n}^{′} \to Eq . 2 with current hidden state {x}_{n} and input \{ {x}_{i}^{′} \vert i ∈ {N}_{c} and ( i , n ) ∈ {E}_{n} \}$
    end for
    $return Next hidden state {x}^{′} and output {x}_{{N}_{m}}^{′}$
```

Algorithm 3: Subroutine - Connect inputs to first hidden layer

```
    for all s ∈ Nᵢ do
      T is random permutation of the set N₁
      for i = 1 ... kₛ do
        p is random variable of distribution {50% [symbol]  1,50% [symbol]  −1}
        Add synapse (s → Tᵢ) to E with polarity p
      end for
    end for
    ${μ}_{i n} ← \frac{1}{\vert {N}_{1} \vert} {\sum }_{t ∈ {N}_{1}} \vert \{ s \vert ( s \to t ) ∈ E \} \vert \{ Compute mean fan - in of neurons {N}_{1} \}$
    for all t ∈ N₁ such that [symbol]   s : (s → t) ∈ E do
      S is random permutation of the set Nᵢ
      for i = 1 ... μᵢₙ do
        p is random variable of distribution {50% [symbol]  1,50% [symbol]  −1}
        Add connection (Sᵢ → t) to E with polarity p
      end for
    end for
```

Algorithm 4: Subroutine - Connect first hidden layer to second layer

```
    for all s ∈ N₁ do
      T is random permutation of the set N2
      for i = 1 ... kᵢ do
        p is random variable of distribution {50% [symbol]  1,50% [symbol]  −1}
        Add synapse (s → Tᵢ) to E with polarity p
      end for
    end for
    ${μ}_{i n} ← \frac{1}{\vert {N}_{2} \vert} {\sum }_{t ∈ {N}_{2}} \vert \{ s \vert ( s \to t ) ∈ E \} \vert \{ Compute mean fan - in of neurons {N}_{2} \}$
    for all t ∈ N₂ such that [symbol]   s: (s → t) ∈ E do
      S is random permutation of the set N₁
      for i = 1 ... μᵢₙ do
        p is random variable of distribution {50% [symbol]  1,50% [symbol]  −1}
        Add connection (Sᵢ → t) to E with polarity p
      end for
    end for
```

```
Algorithm 5: Subroutine − Recurrently connect second hidden layer
for i = 1 . . . k_{c} do
  s is random element from N₂
  t is random element from N₂
  p is a random variable of distribution {50% [symbol]   1,50% [symbol]   −1}
  Add connection (s → t) to E
  with polarity p
end for
```

```
Algorithm 6: Subroutine − Connect second hidden layer to output layer
for all t ∈ N₀ do
  S is random permutation of the set N₂
  for i = 1 . . . kₘ do
    p is random variable of distribution {50% [symbol]   1,50% [symbol]   −1}
    Add connection (Sᵢ → t) to E, polarity p
  end for
end for
```

The key to the robust performance of LTCs under distribution shifts is their ability to dynamically capture the true cause-and-effect of their given task. This can be shown analytically to the fact that LTCs are dynamic causal models, a framework through which models can account for internal and external interventions with independent mechanisms. It has been theoretically shown that the learning system described by an LTC network of Eq. 1 can control internal and external interventions by their network parameters θ, and thus, reduces to a dynamical causal model, as long as f is monotonically increasing, bounded and Lipschitz-continuous.

Causality focuses the attention of LTCs on the task rather than the context of the task. This is leveraged herein such that tasks learned in one environment can be transferred to different environments for LTC networks.

More formally, consider a sequence of task steps T, a sequence of robot/world configurations C, and a sequence of images V. Visual data is generated following a schematic graphical model:
T→C→V

It can then be explained how causal understanding implies knowing: (1) robot states cause images, and not vice-versa (so when training on images and control inputs, the network should output positive velocity when it is required for the task, not because it has learned that a sequence of images moving forward implies that the drone is moving forward), and (2) the autonomous robot's motion is governed by the task (e.g., centering the target in the frame) and not other visual correlations in the data. It is recognized herein that condition (2) may be difficult to achieve for existing networks.

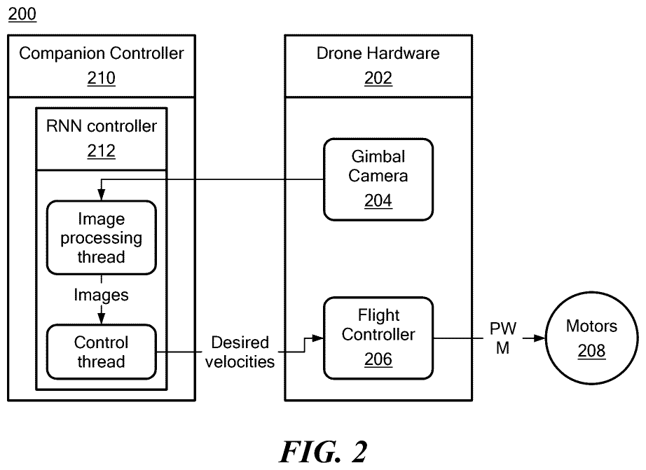

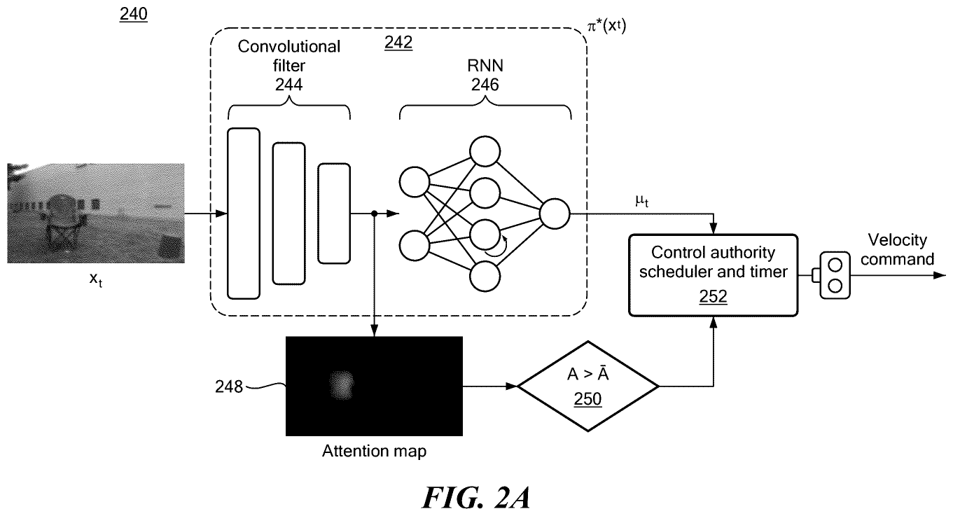

FIG. 2 shows an example of a robotic system 200 utilizing a Sparse-CfC network to learn and/or execute navigation tasks with OOD generalization, according to some embodiments. Illustrative system 200 includes drone hardware 202 and an onboard companion computer 210 configured to run a recurrent neural network (RNN) having a Sparse-CfC architecture as disclosed herein. An RNN is a class of neural networks having recurrent connections and Sparse-CfC, disclosed herein, is an example of an RNN.

Drone hardware 202 may be provided as a commercially available quadcopter (e.g., a DJI M300 RTK quadcopter) with custom software running onboard. The M300 is an enterprise-grade drone that can be flown by manual control in its default configuration. Drone hardware 202 may include a forward-facing gimbal-mounted camera 204 (e.g., a ZENMUSE Z30 camera) and a GPU to run onboard inference. ROS can handle communication between the RNN inference code (RNN controller 212) and the lower-level drone flight controller 206.

Drone hardware 202 may interface with a companion computer 210 (e.g., a DJI Manifold 2 companion computer), enabling programmatic control of the drone. The companion computer 210 can include, for example, an NVIDIA JETSON TX2, which has a CPU and GPU. In some cases, an onboard SDK (e.g., a DJI Onboard SDK) and its associated ROS wrapper can provide an interface for giving the drone's low-level flight controller desired linear and angular velocity setpoints. A flight controller 206 can control the four-rotor speeds (motors 208) to track the velocities specified by the companion computer 210.

Gimbal camera 204 may be mounted on the underside of the drone, pointed forward. The gimbal compensates for the drone's current orientation, such that the roll or pitch of the drone does not result in the roll or pitch of the camera image. The gimbal follows the drone's current yaw such that the camera is always pointed forward. Images from the camera are available to the companion computer 210 via the SDK.

One or more components of system 200 may be implemented in ROS. For example, components used to issue control comments to the robot (sometimes referred to as the software control system) may be implemented in ROS. In some embodiments, an ROS node can be implemented to receive images from the onboard camera, run inference with an RNN controller 212 to compute the new desired control based on the current image, and send the generated control outputs to the low-level flight controller 206 using the onboard ROS SDK. RNN controller 212 can implement an RNN having a Sparse-CfC architecture. For example, RNN controller 212 may implement Algorithms 1 to 6 from above. The node may have two threads: one responsible for processing incoming images, and the other responsible for running inference on the images and sending the resulting control signals to the flight controller. In some embodiments, the companion computer 210 can run RNN inference with GPU-accelerated TENSORFLOW.

It will be appreciated that a robotic system implementing structures and techniques disclosed herein may include various other hardware and/or software components that are omitted from FIG. 2 for reasons of clarity. For example, system 200 may include one or more processors (e.g., CPUs and/or GPUs), a position sensor (e.g., GPS receiver), one or more radios (e.g., cellular radio, Wi-Fi adapter, Bluetooth radio, etc.), a power supply (e.g., battery), nonvolatile memory configured to store various computer instructions, etc.

While FIG. 2 shows an example drone-type robotic system, the general concepts, structures, and techniques sought to be protected herein may be used with various other types of edge robots or autonomous agents.

FIG. 2A shows an example of a neural network controller architecture 240 that may be used within the system of FIG. 2, according to some embodiments. Illustrative neural network controller architecture 240 comprises a neural network 242 having a convolutional filter 244 and an RNN 246, where the RNN 246 may be provided as a Sparse-CfC network as disclosed herein.

Architecture 240 may make use of attention map 248 triggered hops. In more detail, the RNN can navigate the robot (e.g., drone) until the most salient and largest patch on the network attention map reaches an area A that is larger than a detection threshold

$$\\ \overline{A} ,$$

as shown by decision block 250. This triggers a switch of control authority (by scheduler and timer 252) from the network 242 to a fixed time constant throttle command, after which the network 242 regains control until the area criterion is met again, and so on.

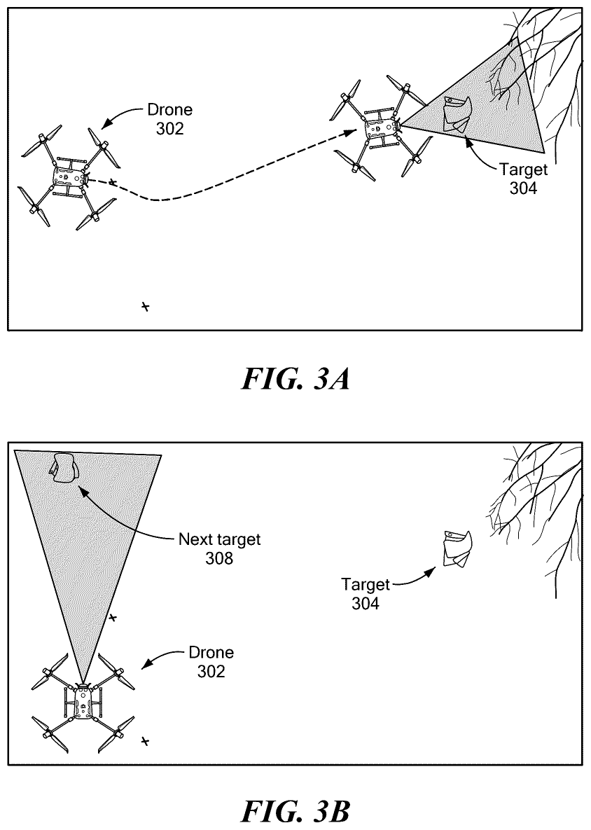

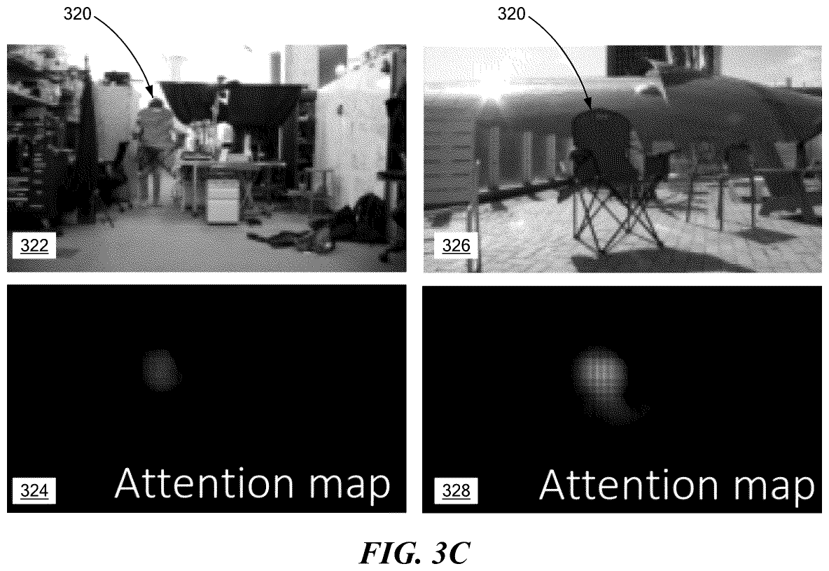

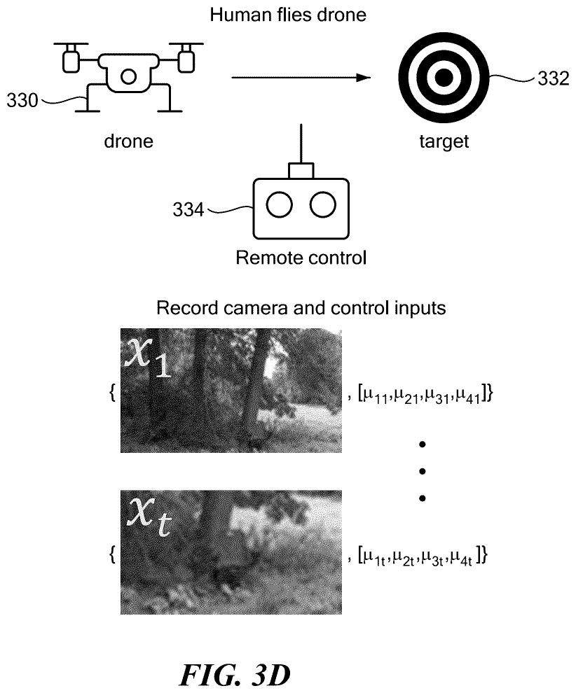

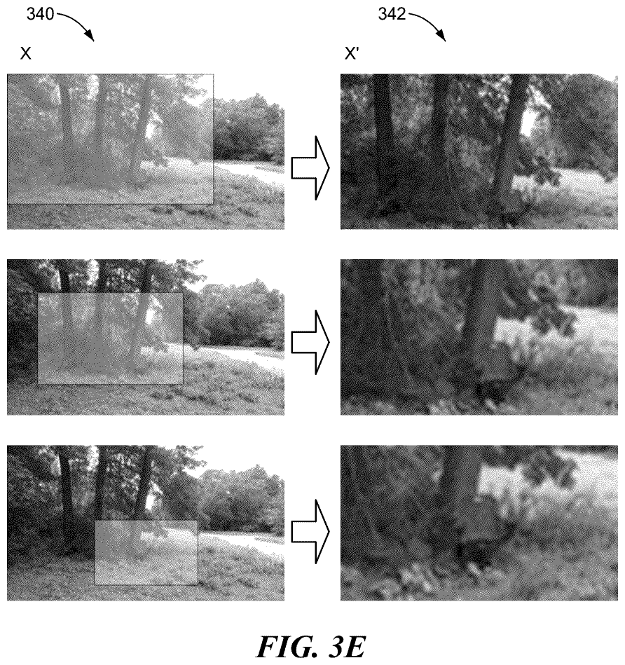

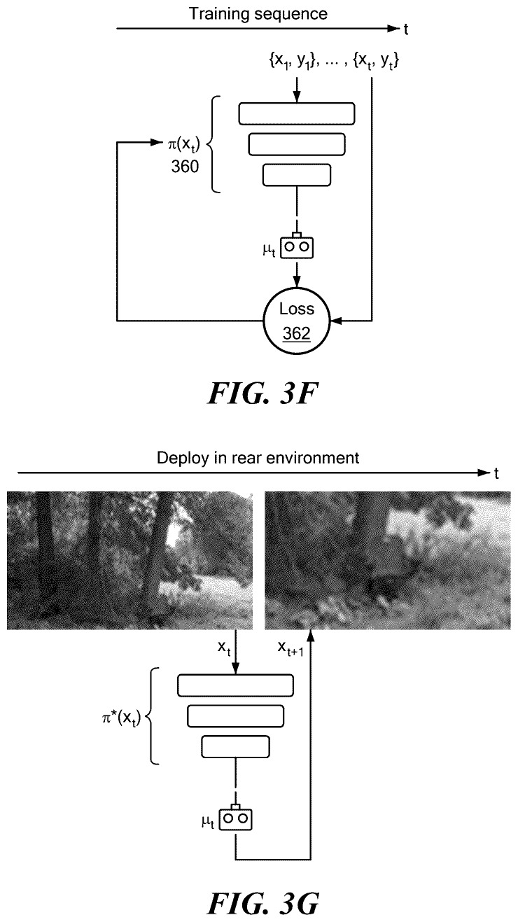

Turning to FIGS. 3A-G, the concepts, structures, and techniques disclosed herein can be used to execute fly-to-target tasks where neither the concept of objects nor the task itself is given to the agent. The agents must learn/understand the task, the scene, and the object, from offline data without any guidance on what the scene, object, and the task are. In this setting, supervised learning of object detection may be out of scope, e.g., because it is not practical or desirable to use labeled data (bounding boxes). Disclosed techniques can be used to learn the task and scene end-to-end from data and generalize to unseen and heavily shifted environments (e.g., change of scenery, weather conditions, other natural adversaries, etc.).

FIG. 3A shows an example of learning to navigate a drone 302 to a target 304 from offline demonstrations. In more detail, using only images taken from an onboard camera, navigate the drone 302 from its starting location to a target 304 (e.g., a target about 10 m away), keeping the target 304 in the frame as the drone navigations along a path (illustrated by a dashed line in the figure).

FIG. 3B illustrates how disclosed structures and techniques can be used to generalize robustly to unseen scenarios in closed-loop with environment. In particular, the generalization capabilities of various neural architectures described herein can be used to execute tasks adapted to previously unseen environments. As shown, after target 304, drone 302 can navigate to a next target 308 and so on and so forth.

FIG. 3C illustrates the causal mechanisms underlying different networks' behaviors while completing the task, i.e., by visualizing the network input saliency map. Referring to the left side of FIG. 3C, a target 320 (e.g., a chair) can be placed within a first environment 322 (e.g., a lab). A corresponding attention map 324 may be generated using disclosed Sparse-CfC techniques. The same or similar target 320 may be placed within a second environment 326 (e.g., a balcony) that is drastically different from the first 322. A corresponding attention map 328 may be generated, also using disclosed Sparse-CfC techniques. This demonstrates that the Sparse CfC technology consistently pays attention to the target generally regardless of its environment.

FIGS. 3D-F illustrates a process for training a neural network for use with an autonomous robot (e.g., a drone), according to some embodiments.

In FIG. 3D, the training process starts by hand-collecting human expert trajectories as a drone 330 is flown towards a target 332 using a remote control 334. During this step, camera observations x₁ . . . xₜ and human expert actions [μ₁₁, μ₂₁, μ₃₁, μ₄₁] . . . [μ₁ₜ, μ₂ₜ, μ₃ₜ, μ₄ₜ] can be recorded.

In FIG. 3E, to further convey the task, synthetic sequences are then generated by taking images 340 collected during human flights and repeatedly cropping them, creating the appearance of a video sequence 342 in which the drone flies up to the target and centers it in the frame.

In FIG. 3F, the networks can be trained offline on the collected expert sequences using a supervised behavior cloning MSE loss. In the figure, yₜ stand for the robot navigation signals, which may be represented by directional velocities Vₓ, V_{y}, V_{z}, and ω, with ω being the rotational directional velocity. Also shown in the figure is a trained neural network instance 364 (π) and a loss component 364 configured to compute the difference between yₜ and directional velocities predicted by the trained neural network instance 364.

FIG. 3G illustrates operation of an autonomous robot using a trained network model (e.g., trained using the process of FIGS. 3D-F), according to some embodiments. As shown, trained networks can be deployed on the drone in online testing. Using the trained networks, the robot can perform tasks under heavy distributional shifts, varying lighting, starting location, wind, background setting, and more.

Next describes are details for preparation of the data and hyperparameters that can be used for training onboard models, according to some embodiments.

Training runs can be collected as long sequences in which the drone moved between multiple (N) targets. To better encode the task for the networks, for each training run of N targets, the approach to each of the N targets can be spliced into N separate training sequences and added these new sliced sequences to the training data.

To increase the networks' robustness and generalization capabilities, various image augmentations may be performed during training. For example, a first set of augmentations can include a random brightness shift with brightness offsets selected uniformly at random ranging from 0-0.4× of the max pixel brightness, a random contrast shift with a contrast factor between 0.6-1.4, and a random saturation multiplication between 0.6-1.4. Parameters for the aforementioned image augmentations can be fixed within a sequence but randomized between sequences so that two images within the same training sequence would have identical brightness, contrast, and saturation offsets, but two images in different sequences would have different offsets. Next, Gaussian random noise can be added to each image (e.g., noise with a mean of 0, and a standard deviation of 0.05 added).

Additionally, in order to better convey the task, closed-loop augmentation can be performed by generating synthetic image and control sequences and adding them to the training set. To generate these sequences, a single image can be taken with the target present and the image can be repeatedly cropped. Over the duration of the synthetic sequence, the center of the crop can be moved from the edge of the image to the center of the target, causing the target to appear to move from the edge of the frame to the center. Additionally, the size of the cropped window can be shrunk while upscaling all of the cropped images to the same size, causing the target to appear to grow bigger. Together, these image procedures simulate moving the drone to center the target while moving closer to the target to make it occupy more of the drone's view. Still frames of the central target can then be inserted, with a commanded velocity of zero for 20-35% of the total sequence length. This pause can teach the drone to pause after centering the target. Algorithm 7 describes the synthetic sequence generation steps, while FIG. 3E visualizes the successive crops calculated by the algorithm and their resulting output frames.

To generate the velocity controls for the synthetic sequence, yaw commands can be generated equal to the horizontal distance in pixels between the target and the center of the frame times a certain value (e.g., 0.01) and likewise generated throttle (up-down) commands equal to the vertical target offset times a certain value (e.g., 0.01). Pitch (forward-backward) commands can be generated in the synthetic data proportional to the size of the cropped window. This technique may be used to increase the size of the training set (e.g., by over 2.5×) using a relatively small sample of images in which the target was present.

Algorithm 7: Synthetic Sequence Generation

```
Require: Image dataset D, dataset size param k₁, max zoom k₂, control gains kₚ, kₜ, k_{y}
  Initialize A := Ø
  for i =1 to k₁ · |D| do
    Initialize Aᵢ := Ø
    Randomly sample sequence augmentation params: T, o~U, b~Dₓ
    for t = 1 to T do
      $Compute sequence completion fraction f := \frac{T - t}{T}$
      Linearly interpolate frame offset oₜ := o · f and frame zoom zₜ := k_{z} · f
      Let c := crop(image = b, offset = oₜ, zoom = zₜ)
      Let v := [pitch = kₚzₜ, roll = 0, throttle = kₜo_{ty}, yaw = kₜoₜₓ]
      Add sample t to Aᵢ ← Aᵢ ∪ (c, v)
    end for
    Update dataset A ← A ∪ Aᵢ
end for
return A
```

The initial position of the target within the frame can be chosen randomly such that the x (horizontal) offset and y offsets of the target are within desired ranges. For example, in the case of 144×256 pixel images, the x offset range may be between 10 and 70 pixels, and the y offset range may be between 5 and 40 pixels. Synthetic sequences can be balanced such that the mean control signal across all generated data points is zero for the throttle and yaw channels. The sequence length can also be randomized to be between within a certain range of frames (e.g., between 120 to 250 frames) to encourage robustness to external forces or varying update frequencies.

In some cases, Tree-structured Parzen estimators (TPE) may be used for hyperparameter tuning: to find hyperparameters such as learning rate (LR), LR decay rate, and model-specific hyperparameters such as backbone unit count or connection seed that would maximize a network architecture's performance.

In order to simultaneously learn the geospatial constructs present in the long, uncut sequences and the task-focused controls present in the cut and synthetic sequences, fine-tuning may be performed on a model trained on the long sequences with sequences featuring only one target.

The starting checkpoint can be trained on the original uncut sequences, all sliced sequences, and synthetic data corresponding to all targets. Then, synthetic data can be regenerated with new randomized offsets for one target and fine-tuned on sliced sequences containing the one target and new synthetic augmented sequences that featured that target.

After hyperparameter optimization is completed, each model can be trained multiple (M) times with the best set of hyperparameters. Among these M training runs, the models with the best overall training and validation loss can be selected for use on the drone. Algorithm 8 summarizes a high-level learning procedure that may be used, according to some embodiments.

Algorithm 8: Learning Procedure: Generate networks for online testing

```
Require: Expert training dataset D =
[(x₁, [y₁₁, y₁₂, y₁₃, y₁₄ ]), ... (xₜ, [yₜ₁, yₜ₂, yₜ₃, yₜ₄])]
    call Algorithm 7 on D to generate synthetic dataset: A
    Aggregate datasets D ← D ∪ A
    call Algorithm 9 on D to train policy π
    $Extract sequences containing specific target \hat{D} := subsample ( D , target = t )$
    $call Algorithm 7 on \hat{D} to generate synthetic dataset : \hat{A}$
    $Aggregate datasets \hat{D} ← \hat{D} ⋃ \hat{A}$
    $call Algorithm 9 on \hat{D} M times$
    $return policy trained on \hat{D} with best over train loss \hat{π}$
```

Algorithm 9: Training Algorithm

```
Require: Dataset D = (X, Y), sequence length l, strid s, batch size b
  $Initialize sliced dataset \hat{D} := ∅$
  for i = 1 to |D| do
    Let sequence start m := 0
    $while m + l \leq \vert {D}_{i}^{x} \vert$
      Slice sequence into subsequence d := Dᵢ[m:m + l:s]
      Update sequence start m := m + l
      $Append sequence \hat{D} ← \hat{D} ⋃ d$
    end while
  end for
  $Split sequence \hat{D} into train set {\hat{D}}^{t} and validation on set {\hat{D}}^{v}$
  Randomly initialize weights [symbol]
  Note best loss l_{best} := ∞
  for e = 1 ... epochₘ do
    $for batch ( x , y ) of size b randomly drawn from {\hat{D}}^{t} do$
      Compute loss L := MSE(f(x, w), y)
      $Perform weight update 𝓌 := 𝓌 - {∝}_{ADAM} \frac{\partial L}{\partial 𝓌}$
    end for
    $Compute validation loss {l}_{v} on {\hat{D}}^{v}$
    if l_{best} ≤ lₑ then
      l_{best} := lₑ [symbol]
      _{best} := [symbol]
    end if
  end for
  return [symbol] _{best}
```

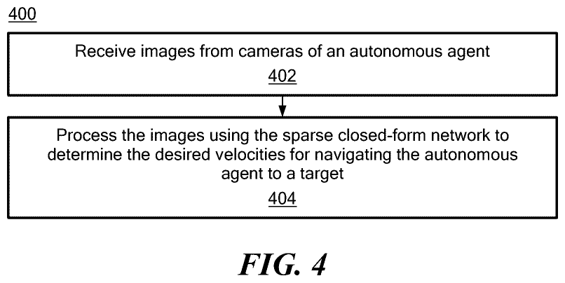

FIG. 4 shows a method 400 for navigating an autonomous agent to a target using a Sparse-CfC network, according to some embodiments. Method 400 can be implemented on and/or executed by one or more processors of a robotic system, such as robotic system 200 of FIG. 2.

At block 402, images can be received from one or more cameras of an autonomous agent, the images being image of an environment in which the autonomous agent is operating. The autonomous agent can have one or more motors and a controller configured to command the motors to move the autonomous agent with desired velocities. In some cases, the agent may be a quadcopter or other type of drone.

At block 404, the images can be processed using a sparse closed-form network to determine the desired velocities for navigating the autonomous agent to a target. In some embodiments, the sparse closed-form network can be generated using any or all of Algorithms 1-6 from above. In some embodiments, the network can be trained on image data collected during one or more prior operations during which the autonomous agent is navigated to the target. Such training runs can be performed within another environment different from the environment in which the autonomous agent is subsequently operating. In some embodiments, training may be done using any or all of Algorithms 7-9 from above. In some embodiments, the sparse closed-form network may be provided as a recurrent neural network (RNN) having a connectome architecture.

The brain-inspired networks disclosed herein can generalize to both new OOD environments and to new tasks significantly better than popular state-of-the-art recurrent neural networks, a crucial characteristic for implementation in real-world applications. It is appreciated herein that this is associated with at least two factors: 1) During the end-to-end training, liquid networks impose an inductive bias on the convolutional filters of the head network, which enable a more robust feature representation associated with the task at hand. The saliency maps of the convolutional head networks are great empirical evidence of this fact. 2) Liquid networks are dynamic causal models at their cell level. The biological priors imposed on liquid networks form a dynamical system that enables mechanisms for regulating external and internal interventions, which are the necessary pillars of causal models. This way, during training, they manage to interact with the training data in a causal fashion to learn representations for both control and perception.

The generalization of end-to-end imitation agents heavily relies on the data they have seen and the augmentation strategies in place to help encode the task in network weights. Using a data augmentation pipeline can significantly improve the perception module of all networks and therefore enable them to obtain stable saliency maps with attention centered on the target.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can include internal processors or modules that perform portions of the function, operation, or sequence of operations. Similarly, a module can include internal processors or internal modules that perform portions of the function, operation, or sequence of operations of the module.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A system comprising:
an autonomous agent having:
one or more cameras configured to receive images of an environment in which the autonomous agent is operating,
one or more motors, and
a controller configured to command the motors to move the autonomous agent with desired velocities; and
a sparse closed-form network configured to process the images to determine the desired velocities for navigating the autonomous agent to a target.

2. The system of claim 1 wherein the sparse closed-form network is trained on image data collected during one or more prior operations during which the autonomous agent is navigated to the target.

3. The system of claim 2 wherein that training runs are performed within another environment different from the environment in which the autonomous agent is subsequently operating.

4. The system of claim 1 wherein the autonomous agent comprises a drone.

5. The system of claim 1 wherein the autonomous agent comprises a quadcopter.

6. The system of claim 1 wherein the sparse closed-form network is provided as a recurrent neural network (RNN).

7. The system of claim 1 wherein the sparse closed-form network has a connectome architecture.

8. The system of claim 7 comprising one or more processors configured to generate the connectome architecture by:
creating Sparse-CfC wiring; and
running inference on the Sparse-CfC wiring.

9. The system of claim 8 wherein the one or more processors are configured to create the Sparse-CfC wiring by:
connecting inputs to a first hidden layer of a graph;
connecting the first hidden layer to a second hidden layer of the graph;
recurrently connecting the second hidden layer of the graph; and
connecting the second hidden layer of the graph to an output layer of the graph.

10. A computer-implemented method comprising:
receiving images from one or more cameras of an autonomous agent, the images being image of an environment in which the autonomous agent is operating, the autonomous agent having one or more motors and a controller configured to command the motors to move the autonomous agent with desired velocities; and
processing the images using a sparse closed-form network to determine the desired velocities for navigating the autonomous agent to a target.

11. The method of claim 10 wherein the sparse closed-form network is trained on image data collected during one or more prior operations during which the autonomous agent is navigated to the target.

12. The method of claim 11 wherein that training runs are performed within another environment different from the environment in which the autonomous agent is subsequently operating.

13. The method of claim 10 wherein the autonomous agent comprises a drone.

14. The method of claim 10 wherein the autonomous agent comprises a quadcopter.

15. The method of claim 10 wherein the sparse closed-form network is provided as a recurrent neural network (RNN).

16. The method of claim 10 wherein the sparse closed-form network has a connectome architecture.

17. The method of claim 16 further comprising generating the connectome by:
creating Sparse-CfC wiring; and
running inference on the Sparse-CfC wiring.

18. The method of claim 17 wherein the creating of the Sparse-CfC wiring includes:
connecting inputs to a first hidden layer of a graph;
connecting the first hidden layer to a second hidden layer of the graph;
recurrently connecting the second hidden layer of the graph; and
connecting the second hidden layer of the graph to an output layer of the graph.
